(19) United States
(12) Patent Application Publication
(10) Pub. No.: US 2020/0198697 A1
(43) Pub. Date: Jun. 25, 2020

(54) POWER CONVERSION DEVICE, MOTOR MODULE, ELECTRIC POWER STEERING DEVICE

(71) Applicant: Nidec Corporation, Kyoto (JP)

(72) Inventor: Kaori NABESHI, Kyoto (JP)

(21) Appl. No.: 16/629,050

(22) PCT Filed: Jun. 7, 2018
(86) PCT No.: PCT/JP2018/021940

§ 371 Date: Jan. 7, 2020

(30) Foreign Application Priority Data
Jul. 26, 2017 (JP) 2017-144281

(51) Int. Cl. B62D 5/04; H02M 7/493; H02P 29/032; H02P 29/028; H02P 27/08

(52) U.S. Cl. CPC B62D 5/0487; H02M 7/493; H02P 27/085; B62D 5/0463; H02P 29/028; H02P 29/032

(57) ABSTRACT

A power conversion device includes a first inverter connected to one end of a winding of each phase of a motor of n phases, n being an integer equal to or greater than 3, a second inverter connected to the other end of the winding of each phase, and at least two drivers to drive n H bridges including windings of n phases, n legs of the first inverter, and n legs of the second inverter. Each of the n H bridges is connected to any one of the at least two drivers.

### CROSS REFERENCE TO RELATED APPLICATIONS

This is a U.S. national stage of PCT Application No. PCT/JP2018/021940, filed on Jun. 7, 2018, and priority under 35 U.S.C. § 119(a) and 35 U.S.C. § 365(b) is claimed from Japanese Application No. 2017-144281, filed Jul. 26, 2017; the entire contents of each application being hereby incorporated herein by reference.

### FIELD OF THE INVENTION

The present disclosure relates to a power conversion device for converting power received from a power supply into power supplied to an electric motor, a motor module, and an electric power steering device.

### BACKGROUND

Recently, electromechanical type motors integrating an electric motor (hereinafter, simply referred to as a ‘motor’) and an electrical control unit (ECU) are developed. Particularly in the field of on-vehicle, high quality assurance is required from the perspective of safety. Therefore, redundant designs capable of continuing safety operation even when some of parts fault are introduced. As an example of redundant design, it is considered to install two inverters for one motor. As another example, it is considered to install a microcontroller for backup, in addition to a main microcontroller.

A power conversion device which connects a first inverter circuit and a second inverter circuit to one motor is known. In a conventional power conversion device, a first pre-driver for driving the first inverter circuit and a second pre-driver for driving the second inverter circuit are installed. The two pre-drivers are controlled by a common microcontroller. In another conventional power conversion device, a first pre-driver for driving the first inverter circuit and a second pre-driver for driving the second inverter circuit are installed. The first pre-driver is controlled by a first microcontroller, and the second pre-driver is controlled by a second microcontroller. According to the configuration like this, although a pre-driver of one side is faulty, driving of the motor can be continued by using the pre-driver of the other side and the inverter connected thereto.

In the conventional technique described above, it is required to further improve the control when a pre-driver or the like needed to drive an inverter is faulty. A fault of the pre-driver, in addition to disconnection of a winding or a fault of a switch element of the inverter, is also considered as a fault of the power conversion device. When one of two pre-drivers is faulty in the conventional power conversion device, it is difficult to flow current through windings of a motor by using the inverters on both sides.

### SUMMARY

An exemplary power conversion device of the present disclosure is a power conversion device to convert power received from a power supply into power supplied to a motor including windings of n phases, n being an integer equal to or greater than 3), and the device includes a first inverter connected to one end of a winding of each phase of the motor, and including n legs, a second inverter connected to the other end of the winding of each phase, and including n legs, and at least two drivers to drive n H bridges including the windings of n phases, the n legs of the first inverter, and the n legs of the second inverter, wherein each of the n H bridges is connected to any one of the at least two drivers.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a block diagram showing the block configuration of a motor module 2000 according to a first example embodiment of the present disclosure, mainly showing the block configuration of a power conversion device 1000.

FIG. 2 is a circuit diagram showing an example of the circuit configuration of an inverter unit 100 of a power conversion device 1000 according to the first example embodiment of the present disclosure.

FIG. 3 is a circuit diagram showing another example of the circuit configuration of an inverter unit 100 of a power conversion device 1000 according to the first example embodiment of the present disclosure.

FIG. 4 is a block diagram showing connection of a driver 350 and an inverter unit 100 and the block configuration of the driver 350 according to the first example embodiment of the present disclosure.

FIG. 5 is a mimetic view showing the circuit configuration of H bridge HB1 of U phase.

FIG. 6 is a mimetic view showing connection of a driving unit 351, having a first driving unit (DU1) and a second driving unit (DU2), and H bridge HB1.

FIG. 7A is a mimetic view showing an example of hardware configuration of the first driving unit (DU1) and the second driving unit (DU2).

FIG. 7B is a mimetic view showing an example of hardware configuration of the first driving unit (DU1) and the second driving unit (DU2).

FIG. 7C is a mimetic view showing an example of hardware configuration of the first driving unit (DU1) and the second driving unit (DU2).

FIG. 8 is a graph illustrating a current waveform (sine wave) obtained by plotting the value of current flowing through the each windings of U phase, V phase, and W phase of a motor 200 when the power conversion device 1000 is controlled according to three-phase current flow control.

FIG. 9A is a mimetic view showing a case in which a driving unit 351 in the driver 350 is faulty.

FIG. 9B is a mimetic view showing a case in which a driving unit 352 in the driver 350 which drives a four-phase motor is faulty.

FIG. 10A is a graph showing an example of a current waveform obtained by plotting the value of current flowing through the each windings of V and W phases of a motor 200 when the power conversion device 1000 is controlled according to two-phase current flow control.

FIG. 10B is a graph showing an example of a current waveform obtained by plotting the value of current flowing through the windings of U and W phases of a motor 200 when the power conversion device 1000 is controlled according to two-phase current flow control using winding M1 of U phase and winding M3 of W phase.

FIG. 10C is a graph showing a current waveform obtained by plotting the value of current flowing through the windings of U and V phases of a motor 200 when the power conversion device 1000 is controlled according to two-phase current flow control using winding M1 of U phase and winding M2 of V phase.

FIG. 11 is a block diagram showing connection of a driver 350 and an inverter unit 100 and the block configuration of the driver 350 according to a second example embodiment of the present disclosure.

FIG. 12 is a block diagram showing the block configuration of each driving unit of the driver 350.

FIG. 13 is a block diagram showing a block configuration when pre-drivers (PDs) are used as a first driving unit (DU1) and a second driving unit (DU2) of each driving unit.

FIG. 14 is a mimetic view showing a case in which the pre-driver (PD) connected to the leg for U phase of a first inverter 120 of H bridge HB1, among six pre-drivers (PDs), is faulty.

FIG. 15 is a mimetic view showing a typical configuration of an electric power steering device 3000 according to an example embodiment of the present disclosure.

### DETAILED DESCRIPTION

Hereinafter, example embodiments of the present disclosure of a power conversion device, a motor module and an electric power steering device of the present disclosure will be described in detail with reference to the accompanying drawings. However, to avoid unnecessary lengthening of the description and to facilitate understanding of those skilled in the art, detailed descriptions more than necessary may be omitted. For example, detailed descriptions of already known functions or duplicated descriptions of practically the same configurations may be omitted.

In this specification, example embodiments of the present disclosure will be described using a power conversion device which converts power received from a power supply into power supplied to a three-phase motor having windings of three phases (U phase, V phase and W phase) as an example. In addition, a power conversion device which converts power received from a power supply into power supplied to an n-phase motor having windings of n phases (n is an integer equal to or greater than 4), such as four phases, five phases or the like, is still within the scope of the present disclosure.

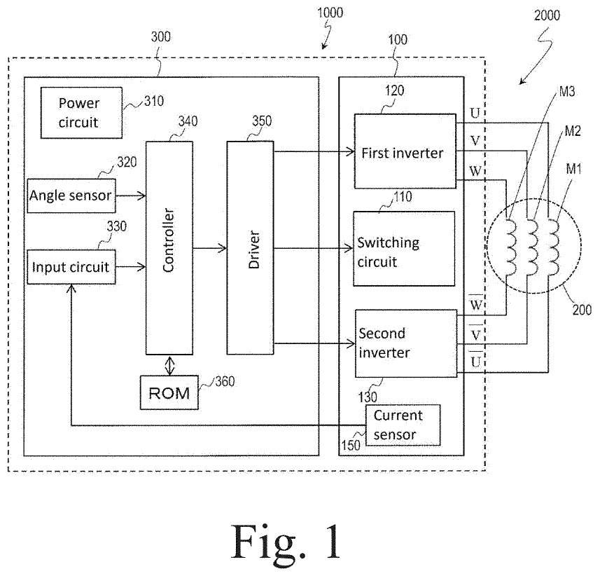

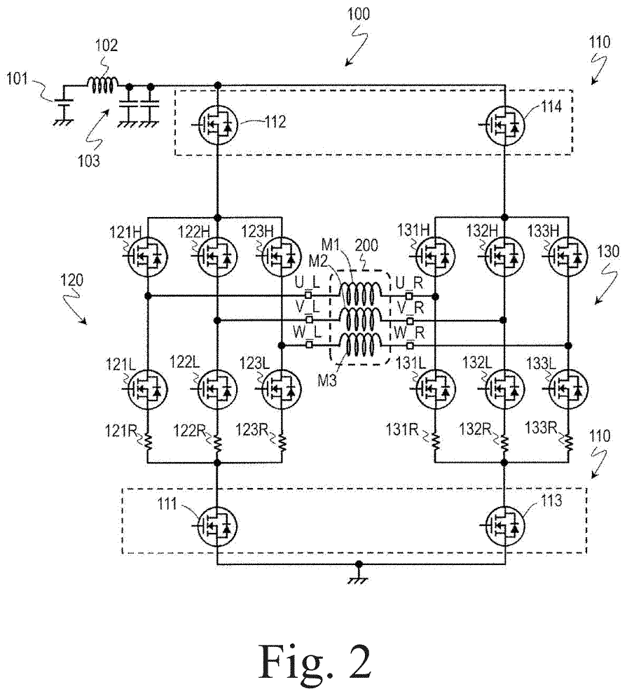

FIG. 1 mimetically shows the block configuration of a motor module 2000 according to a first example embodiment of the present disclosure, mainly mimetically showing the block configuration of a power conversion device 1000. FIG. 2 mimetically shows an example of the circuit configuration of an inverter unit 100 of a power conversion device 1000.

The motor module 2000 includes a motor 200 and a power conversion device 1000. The motor module 2000 is modularized and may be manufactured and sold, for example, as an electromechanical type motor including a motor, a sensor, a pre-driver (also referred to as a ‘gate driver’) and a controller.

The motor 200 is, for example, a three-phase AC motor. The motor 200 has winding M1 of U phase, winding M2 of V phase and winding M3 of W phase and is connected to a first inverter 120 and a second inverter 130 of an inverter unit 100.

The power conversion device 1000 includes the inverter unit 100 and the control circuit 300. The power conversion device 1000 is connected to the motor 200 and also connected to a power supply 101 with the intervention of a coil 102. The power conversion device 1000 may convert power received from the power supply 101 into power supplied to the motor 200. For example, the power conversion device 1000 may convert direct current power into three-phase alternate current power of a pseudo sine wave of U phase, V phase and W phase.

The inverter unit 100 includes, for example, a switching circuit 110, a first inverter 120, a second inverter 130, and a current sensor 150.

The first inverter 120 has terminals U_L, V_L and W_L corresponding to each phase. The second inverter 130 has terminals U_R, V_R and W_R corresponding to each phase. Terminal U_L of the first inverter 120 is connected to one end of winding M1 of U phase, terminal V_L is connected to one end of winding M2 of V phase, and terminal W_L is connected to one end of winding M3 of W phase. Like the first inverter 120, terminal U_R of the second inverter 130 is connected to the other end of winding M1 of U phase, terminal V_R is connected to the other end of winding M2 of V phase, and terminal W_R is connected to the other end of winding M3 of W phase. The motor connection like this is different from the so-called star connection or delta connection.

The first inverter 120 (expressed as a ‘bridge circuit L’ in some cases) includes three legs, each of which has a low side switch element and a high side switch element. A leg for U phase has a low side switch element 121L and a high side switch element 121H. A leg for V phase has a low side switch element 122L and a high side switch element 122H. A leg for W phase has a low side switch element 123L and a high side switch element 123H.

For example, a field effect transistor having a parasitic diode formed inside thereof (typically, a MOSFET) or a combination of an insulated gate bipolar transistor (IGBT) and a free wheeling diode connected thereto in parallel may be used as a switch element. In the first example embodiment of the present disclosure, an example of using a MOSFET as a switching element will be described, and there are cases in which a switch element is expressed as SW. For example, low side switch elements 121L, 122L and 123L are expressed as SW 121L, 122L and 123L.

The first inverter 120 is a current sensor 150 for detecting current flowing through the windings of U phase, V phase and W phase and includes three shunt resistors 121R, 122R and 123R. The current sensor 150 includes a current detection circuit (not shown) for detecting current flowing through each of the shunt resistors. As shown in FIG. 2, for example, the three shunt resistors 121R, 122R and 123R may be connected between the three low side switch elements 121L, 122L and 123L included in the three legs of the first inverter 120 and the GND, respectively.

Like the first inverter 120, the second inverter 130 (expressed as a ‘bridge circuit R’ in some cases) includes three legs, each of which has a low side switch element and a high side switch element. A leg for U phase has a low side switch element 131L and a high side switch element 131H. A leg for V phase has a low side switch element 132L and a high side switch element 132H. A leg for W phase has a low side switch element 133L and a high side switch element 133H. In addition, the second inverter 130 includes three shunt resistors 131R, 132R and 133R. Those shunt resistors may be connected between the three low side switch elements 131L, 132L and 133L included in the three legs and the GND, respectively.

The number of shunt resistors is not limited to three for each inverter. For example, it is possible to use two shunt resistors for U phase and V phase, two shunt resistors for V phase and W phase, and two shunt resistors for U phase and W phase. The number of shunt resistors and disposition of the shunt resistors are properly determined considering the product cost and design specifications and the like.

The switching circuit 110 has first to fourth switch elements 111, 112, 113 and 114. In the inverter unit 100, the first and second inverters 120 and 130 may be electrically connected to the power supply 101 and the GND by the switching circuit 110, respectively. Describing specifically, the first switch element 111 switches connection and disconnection of the first inverter 120 and the GND. The second switch element 112 switches connection and disconnection of the power supply 101 and the first inverter 120. The third switch element 113 switches connection and disconnection of the second inverter 130 and the GND. The fourth switch element 114 switches connection and disconnection of the power supply 101 and the second inverter 130.

On and off of the first to fourth switch elements 111, 112, 113 and 114 may be controlled by, for example, a microcontroller or a dedicated driver. The first to fourth switch elements 111, 112, 113 and 114 may block current of both directions. For example, a semiconductor switch such as a thyristor, an analog switch IC or a MOSFET in which a parasitic diode is generated, a mechanical relay or the like may be used as the first to fourth switch elements 111, 112, 113 and 114. A combination of a diode and an IGBT or the like may be used without a problem. In the first example embodiment of the present disclosure, MOSFETs are used as the first to fourth switch elements 111, 112, 113 and 114. Hereinafter, the first to fourth switch elements 111, 112, 113 and 114 are expressed as SW 111, 112, 113 and 114, respectively.

SW 111 is disposed to flow forward-current through an internal parasitic diode toward the first inverter 120. SW 112 is disposed to flow forward-current through a parasitic diode toward the power supply 101. SW 113 is disposed to flow forward-current through a parasitic diode toward the second inverter 130. SW 114 is disposed to flow forward-current through a parasitic diode toward the power supply 101.

It is not limited to the example shown in the figure, the number of switch elements is properly determined considering the design specifications and the like. Particularly, since high quality assurance is required in the field of on-vehicle from the perspective of safety, it is preferable to install a plurality of switch elements for each inverter.

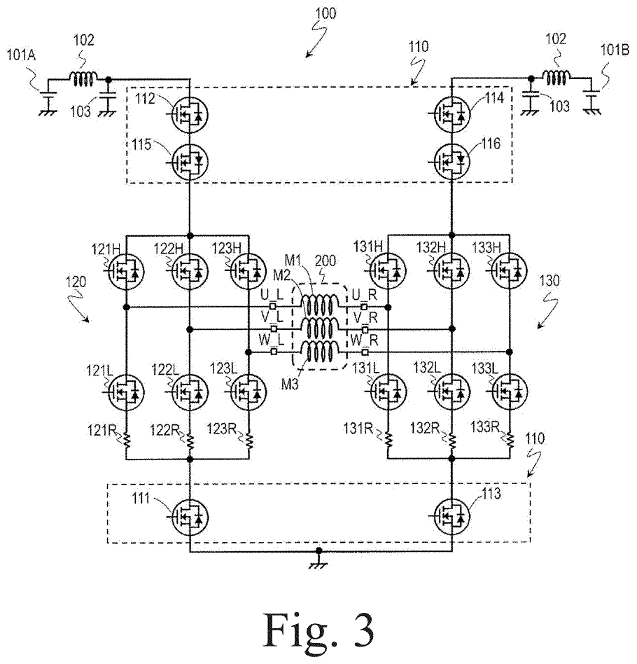

FIG. 3 mimetically shows another circuit configuration of the inverter unit 100 in a power conversion device 1000 according to the first example embodiment of the present disclosure.

The switching circuit 110 may further include fifth and sixth switch elements 115 and 116 for protection against reverse connection. The fifth and sixth switch elements 115 and 116 are typically MOSFET semiconductor switches having a parasitic diode. The fifth switch element 115 is connected to SW 112 in series and disposed to flow forward-current through the parasitic diode toward the first inverter 120. The sixth switch element 116 is connected to SW 114 in series and disposed to flow forward-current through the parasitic diode toward the second inverter 130. Even when the power supply 101 is connected in the reverse direction, reverse current may be blocked by the two switch elements for protection against reverse connection.

The power supply 101 generates a predetermined power voltage (e.g., 12V). As the power supply 101, for example, a DC power supply is used. However, the power supply 101 may be an AC-DC converter, a DC-DC converter, or a battery (storage battery).

The power supply 101 may be a single power supply common to the first and second inverters 120 and 130 or may include a first power supply 101A for the first inverter 120 and a second power supply 101B for the second inverter 130 as shown in FIG. 3.

A coil 102 is installed between the power supply 101 and the switching circuit 110. The coil 102 functions as a noise filter and flattens high frequency noises included in the voltage waveform supplied to each inverter or high frequency noises generated from each inverter so that the noises may not be leaked to the power supply 101 side. In addition, a condenser 103 is connected to the power supply line. The condenser 103 is a so-called bypass condenser and suppresses voltage ripples. The condenser 103 may be, for example, an electrolytic condenser, and the capacity and the number of the condenser can be properly determined according to the design specifications or the like.

Refer to FIG. 1 again.

The control circuit 300 includes, for example, a power circuit 310, an angle sensor 320, an input circuit 330, a controller 340, a driver 350, and ROM 360. The control circuit 300 is connected to the inverter unit 100 and flows current through winding M1, M2 and M3 of the motor 200 by driving the inverter unit 100. In the motor module 2000, each part of the control circuit 300 is installed on, for example, a sheet of circuit board (typically, a printed circuit board).

The control circuit 300 may realize closed loop control by controlling the position, rotation speed, current and the like of the rotor of a targeting motor 200. In addition, the control circuit 300 may include a torque sensor, instead of the angle sensor 320. In that case, the control circuit 300 may control targeting motor torque.

The power circuit 310 generates power voltage (e.g., 3V or 5V) needed for each block in the circuit on the basis of, for example, the voltage of 12V of the power supply 101. The angle sensor 320 is, for example, a resolver or a hall IC. Alternatively, the angle sensor 320 is realized by a combination of an MR sensor having a magnetic resistance (MR) element and a sensor magnet. The angle sensor 320 detects a rotation angle (hereinafter, referred to as a rotation signal) of the rotor of the motor 200 and outputs the rotation signal to the controller 340.

The input circuit 330 receives a motor current value (hereinafter, referred to as a ‘real current value’) detected by the current sensor 150, converts the level of the real current value into the input level of the controller 340 as needed, and outputs the real current value to the controller 340. The input circuit 330 is, for example, an analog-to-digital conversion circuit.

The controller 340 is an integrated circuit for controlling the entire power conversion device 1000 and is, for example, a microcontroller or a field programmable gate array (FPGA). The controller 340 controls switching operation (turn on or turn off) of each SW in the first inverter 120 and the second inverter 130 of the inverter unit 100.

The controller 340 generates a pulse width modulation (PWM) signal by setting a target current value according to the real current value and the rotation signal of the rotor and the like, and outputs the PWM signal to the driver 350. In addition, the controller 340 may control on and off of each switch SW in the switching circuit 110 of the inverter unit 100.

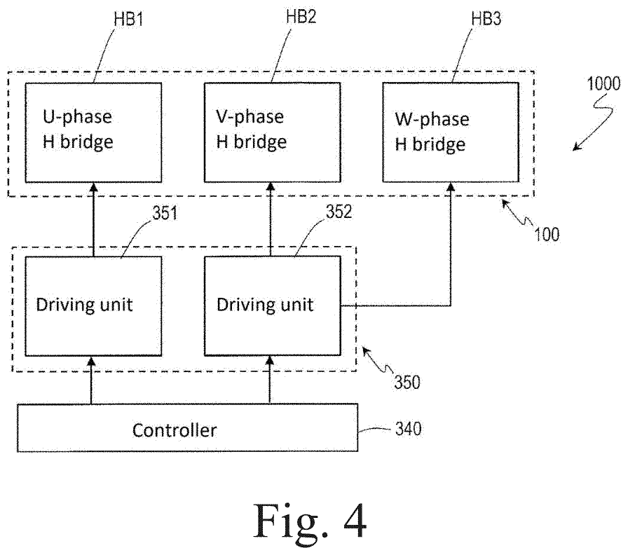

FIG. 4 mimetically shows connection of the driver 350 and the inverter unit 100 and the block configuration of the driver 350 FIG. 5 mimetically shows the circuit configuration of H bridge HB1 of U phase.

The driver 350 may have at least two driving units. In the first example embodiment of the present disclosure, the driver 350 has two driving units 351 and 352. Each of the driving units 351 and 352 may be, for example, a pre-driver. The pre-driver may be a driver of a charge pump type or a bootstrap type. The pre-driver preferably has a plurality of channels for outputting a gate control signal to a plurality of H bridges. According thereto, further more H bridges may be connected to one pre-driver.

The driver 350 creates a gate control signal for controlling switching operation of each SW in the first inverter 120 and the second inverter 130 according to the PWM signal received from the controller 340 and applies the gate control signal to the gate of each SW.

The two driving units 351 and 352 drive three H bridges of H bridge of U phase HB1, H bridge of V phase HB2, and H bridge of W phase HB3 having winding M1, M2 and M3 of three phases, three legs of the first inverter 120, and three legs of the second inverter 130. Each of the three H bridges may be connected to any one of the two driving units 351 and 352. In the first example embodiment of the present disclosure, H bridge HB1 is connected to the driving unit 351, and H bridge HB2 and HB3 are connected to the driving unit 352.

As shown in FIG. 5, H bridge HB1 includes SW 121H and 121L of a leg for U phase of the first inverter 120, SW 131H and 131L of a leg for U phase of the second inverter 130, and winding M1 of U phase. H bridge HB2 (not shown) includes SW 122H and 122L of a leg for V phase of the first inverter 120, and SW 132H and 132L of a leg for V phase of the second inverter 130, and winding M2 of V phase. H bridge HB3 (not shown) includes SW 123H and 123L of a leg for W phase of the first inverter 120, and SW 133H and 133L of a leg for W phase of the second inverter 130, and winding M3 of W phase.

For example, for H bridge HB1, the driving unit 351 is connected to SW 121H, 121L, 131H and 131L and supplies a gate control signal to the gate of the switch elements. For H bridge HB2 and HB3, the driving unit 352 is connected to SW 122H, 122L, 132H and 132L of H bridge HB2 and SW 123H, 123L, 133H and 133L of H bridge HB3, and supplies a gate control signal to the gate of the switch elements.

FIG. 6 mimetically shows connection of the driving unit 351 having a first driving unit (DU1) and a second driving unit (DU2), and H bridge HB1.

In the present disclosure, at least one driving unit among the at least two driving units may have a first driving unit (DU1) and a second driving unit (DU2). In the first example embodiment of the present disclosure, the driving unit 351 has a first driving unit (DU1) and a second driving unit (DU2). Naturally, all the driving units may have a first driving unit (DU1) and a second driving unit (DU2). For example, the driving unit 352 may have a first driving unit (DU1) and a second driving unit (DU2).

The first driving unit (DU1) is connected to SW 121L and SW 121H in the leg for U phase of the first inverter 120 of H bridge HB1. The first driving unit (DU1) supplies a gate control signal for controlling switching operation of SW 121L and SW 121H to the switch elements.

The second driving unit (DU2) is connected to SW 131L and SW 131H in the leg for U phase of the second inverter 130 of H bridge HB1. The second driving unit (DU2) supplies a gate control signal for controlling switching operation of SW 131L and SW 131H to the switch elements.

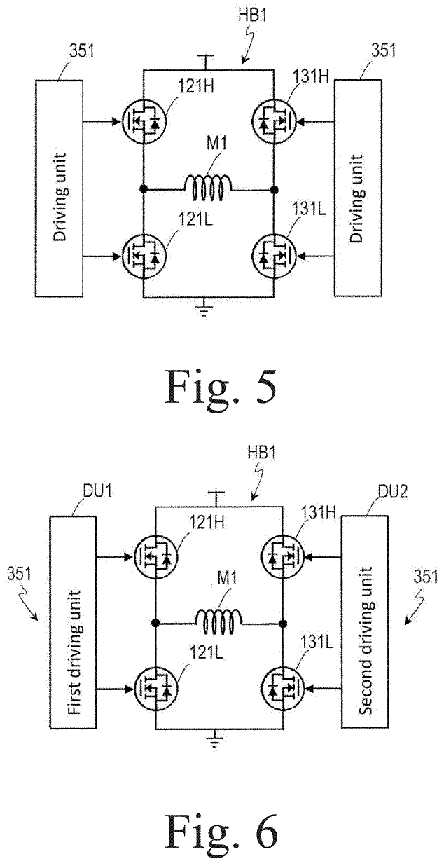

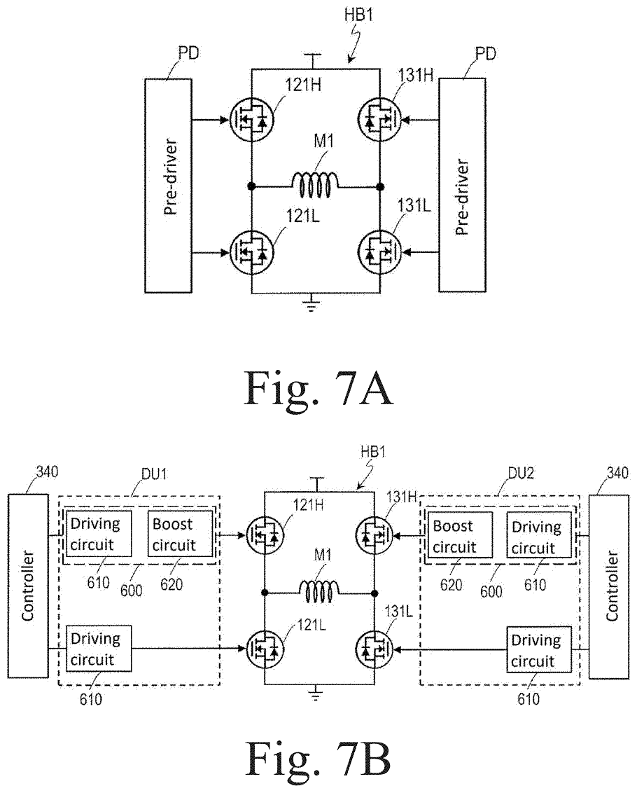

FIGS. 7A to 7C mimetically shows an example of hardware configuration of the first driving unit (DU1) and the second driving unit (DU2). As described below, the first driving unit (DU1) and the second driving unit (DU2) may be installed in the driving unit 351 as separate hardware. The hardware configuration described below may be employed for the driving unit 352.

As shown in FIG. 7A, each of the first driving unit (DU1) and the second driving unit (DU2) may be a pre-driver (PD). A general-purpose product used for driving an inverter may be widely used as the pre-driver (PD). The pre-driver (PD) may be a driver of a charge pump type or a bootstrap type.

As shown in FIG. 7B, each of the first driving unit (DU1) and the second driving unit (DU2) may include a boost driving circuit 600 and a driving circuit 610. In this configuration, all of SW 121H, 121L, 131H and 131L are N-channel transistors.

The boost driving circuit 600 of the first driving unit (DU1) supplies a gate control signal for controlling switching operation of SW 121H in the leg of the first inverter 120 of H bridge HB1 to SW 121H. Power voltage (e.g., 12 V) is supplied from the power source 101 to the boost driving circuit 600. The voltage level of the gate control signal outputted from the boost driving circuit 600 is higher than the voltage level of the power supply 101 and is, for example, 18V. This is because that the reference potential of the source of the high side switch element should be high to be a driving voltage supplied to the winding. As a high voltage is supplied by the boost driving circuit 600 to the gate of SW 121H, a voltage between the gate and the source for properly turning on SW 121H can be secured.

The boost driving circuit 600 of the second driving unit (DU2) has practically the same structure and function as those of the boost driving circuit 600 of the first driving unit (DU1). Hereinafter, the driving circuit 610 and a boost circuit 620 will be described using the boost driving circuit 600 of the first driving unit (DU1) as an example.

For example, the boost driving circuit 600 is separate hardware and may be realized using the driving circuit 610 and the boost circuit 620. The driving circuit 610 has, for example, a push-pull circuit including a bipolar transistor. A general-purpose product may be widely used as the driving circuit 610. The boost circuit 620 is, for example, a boost circuit of a charge pump type. For example, the boost circuit 620 boosts 12V voltage of the power supply 101 to a voltage of 18V and supplies the boost voltage to the driving circuit 610. The driving circuit 610 supplies SW 121H with a gate control signal of a voltage level corresponding to the boost voltage received from the boost circuit 620 according to the PWM signal received from the controller 340. As the boost driving circuit 600, a dedicated circuit of a single body installed with all the functions described above may be used.

The first driving unit (DU1) includes an additional driving circuit 610 different from the driving circuit 610 of the boost driving circuit 600. The driving circuit 610 supplies a gate control signal for controlling switching operation of SW 121L in the leg for U phase of the first inverter 120 to SW 121L according to the PWM signal received from the controller 340.

As shown in FIG. 7C, each of the first driving unit (DU1) and the second driving unit (DU2) may include two driving circuits 610.

One of the two driving circuits 610 is connected to SW 121H in the leg for U phase of the first inverter 120 and supplies a gate control signal for controlling switching operation of SW 121H to SW 121H. The other one is connected to SW 121L in the leg for U phase of the first inverter 120 and supplies a gate control signal for controlling switching operation of SW 121L to SW 121L.

In this hardware configuration, SW 121H and SW 131H are P-channel transistors. SW 121L and SW 131L are N-channel transistors. Like this, as P-channel transistors are used as high side switch elements, the potential supplied to the gate with respect to the reference potential of the source may be lowered. Therefore, each of the first driving unit (DU1) and the second driving unit (DU2) do not need particularly the boost circuit 620.

According to the circuit configuration of the driving unit shown in FIGS. 7A to 7C, for example, although the first driving unit (DU1) or the second driving unit (DU2) of one among the at least two driving units is faulty, propagation of the fault to the other driving units may be properly suppressed. Therefore, driving units other than the driving unit which is faulty may be continuously used.

Referring to FIG. 1 again.

The ROM 360 is, for example, writable memory (e.g., PROM), rewritable memory (e.g., flash memory) or read only memory. The ROM 360 stores control programs including command groups for controlling the power conversion device 1000 in the controller 340. For example, the control program is once deployed in the RAM (not shown) during a booting process.

The power conversion device 1000 has control at normal time and control abnormal times. The control circuit 300 (mainly the controller 340) may switch control of the power conversion device 1000 from control at normal times to control at abnormal times. In this specification, an abnormal state mostly means a fault of at least one driving unit. For example, a fault of a driving unit means a fault of the pre-driver, the boost driving circuit 600 or the driving circuit 610 described above.

First, a specific example of a control method at normal times of the power conversion device 1000 will be described. At normal times, any one of winding M1, M2 and M3 of three phases of the power conversion device 1000 and the motor 200 is not faulty.

The controller 340 outputs a control signal for turning on SW 111, 112, 113 and 114 of the switching circuit 110. According thereto, all of SW 111, 112, 113 and 114 are turned on. The power supply 101 and the first inverter 120 are electrically connected, and power supply 101 and the second inverter 130 are electrically connected. In addition, the first inverter 120 and the GND are electrically connected, and the second inverter 130 and the GND are electrically connected.

The controller 340 outputs a PWM signal for controlling switching operation of the switch elements of both the first inverter 120 and the second inverter 130 to the driving units 351 and 352 (see FIG. 4). The motor 200 may be driven by flowing current through winding M1, M2 and M3 of three phases by turning on and off all the switch elements of H bridge HB1, HB2 and HB3. In this specification, flowing current through the windings of three phases is referred to as a ‘three-phase current flow control’.

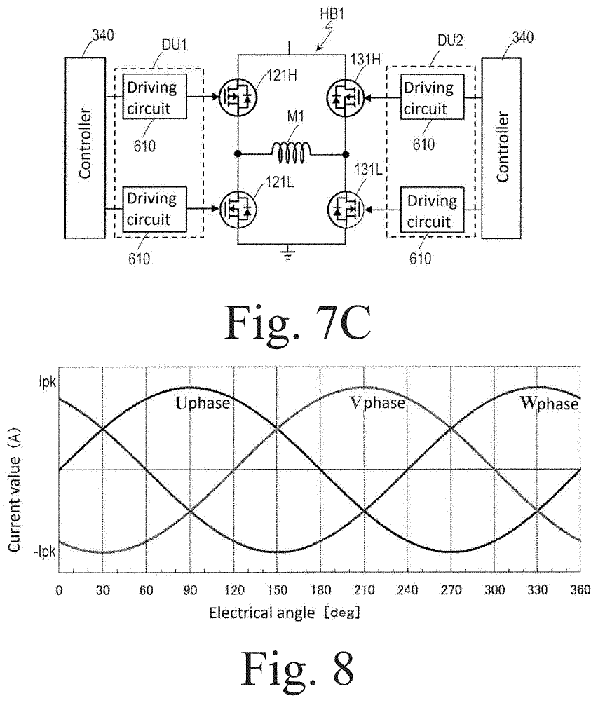

FIG. 8 shows an example of a current waveform (sine wave) obtained by plotting the value of current flowing through the each windings of U phase, V phase, and W phase of a motor 200 when the power conversion device 1000 is controlled according to three-phase current flow control. The horizontal axis represents an electrical angle (deg) of the motor, and the vertical axis represents the current value (A). In the current waveform of FIG. 8, current values are plotted every 30° of the electrical angle. Iₚₖ denotes the maximum current value (peak current value) of each phase.

Table 1 shows values of current flowing through the terminal of each inverter at each electrical angle in the sine wave of FIG. 8. Specifically, Table 1 shows values of current flowing through terminal U_L, V_L and W_L of the first inverter 120 (bridge circuit L) every 30° of electrical angle, and values of current flowing through terminal U_R, V_R and W_R of the second inverter 130 (bridge circuit R) every 30° of electrical angle. Here, for the bridge circuit L, the direction of current flowing from the terminal of the bridge circuit L to the terminal of the bridge circuit R is defined as forward direction. The direction of current shown in FIG. 8 follows this definition. In addition, for the bridge circuit R, the direction of current flowing from the terminal of the bridge circuit R to the bridge circuit L is defined as forward direction. Therefore, the difference of phase between the current of the bridge circuit L and the current of the bridge circuit R is 180°. In Table 1, magnitude of current value I₂ is [(3)^{1/2}/2]*Iₚₖ, and magnitude of current value I₂ is Iₚₖ/2.

TABLE 1

| Operation at | | Electrical angle [deg] | | | | | | | | | | | |
|---|---|---|---|---|---|---|---|---|---|---|---|---|---|
| normal times | | 0 (360) | 30 | 60 | 90 | 120 | 150 | 180 | 210 | 240 | 270 | 300 | 330 |
| Bridge | U_L phase | 0 | I₂ | I1 | Iₚₖ | I₁ | I₂ | 0 | −I₂ | −I1 | −Iₚₖ | −I₁ | −I₂ |
| circuit L | V_L phase | −I1 | −Iₚₖ | −I₁ | −I₂ | 0 | I₂ | I₁ | Iₚₖ | I₁ | I₂ | 0 | −I₂ |
| | W_L phase | I₁ | I₂ | 0 | −I₂ | −I1 | −Iₚₖ | −I₁ | −I₂ | 0 | I₂ | I₁ | Iₚₖ |
| Bridge | U_R phase | 0 | −I₂ | −I1 | −Iₚₖ | −I1 | −I₂ | 0 | I₂ | I₁ | Iₚₖ | I₁ | I₂ |
| circuit R | V_R phase | I₁ | Iₚₖ | I₁ | I₂ | 0 | −I₂ | −I1 | −Iₚₖ | −I1 | −I₂ | 0 | I₂ |
| | W_R phase | −I1 | −I₂ | 0 | I₂ | I₁ | Iₚₖ | I₁ | I₂ | 0 | −I₂ | −I1 | Iₚₖ |

In the current waveform shown in FIG. 8, the total of current flowing through the windings of three phases considering the direction of current becomes ‘0’ at each electrical angle. However, according to the circuit configuration of the power conversion device 1000, since the current flowing through the windings of three phases can be independently controlled, it may be controlled to make the total of current not to be ‘0’. For example, the controller 340 outputs a PWM signal for obtaining the current waveform shown in FIG. 8 to the driving units 351 and 352.

Next, a specific example of the control method of the power conversion device 1000 at abnormal times is described using a case in which the driving unit 351 is faulty as an example.

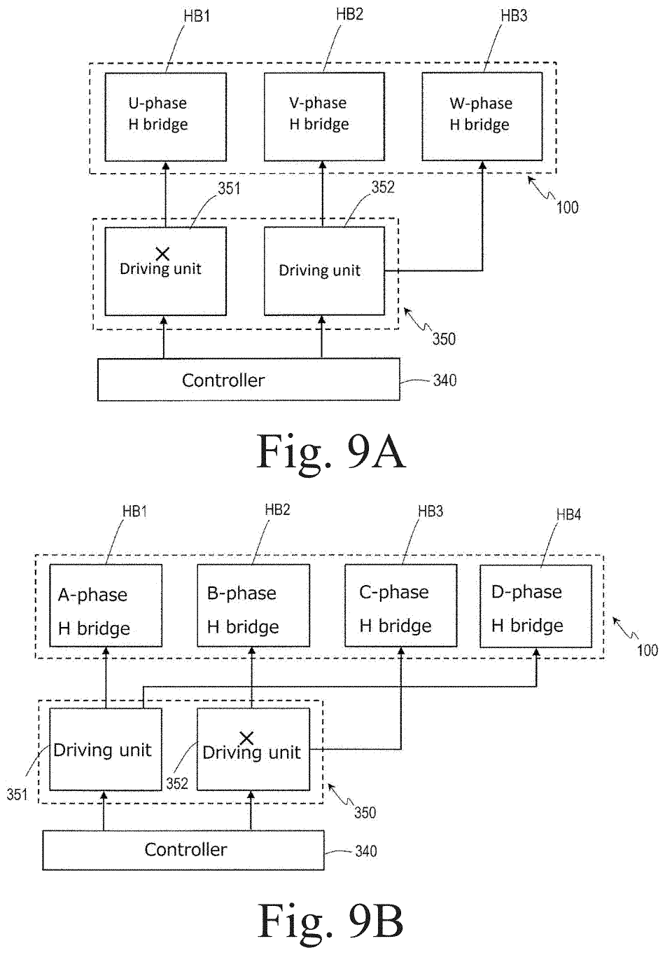

FIG. 9A mimetically shows a case in which a driving unit 351 in the driver 350 is faulty. The controller 340 may detect a fault of at least one of the at least two driving units. In the first example embodiment of the present disclosure, the controller 340 may detect a fault of the driving unit 351 or 352. For example, when the driving unit 351 is faulty, a status signal indicating the fault is transmitted to the controller 340. The controller 340 detects the fault of the driving unit 351 by receiving the status signal and switches control of the power conversion device 1000 from control at normal times to control at abnormal times.

As shown in the figure, when the driving unit 351 is faulty, the driving unit 351 may not drive H bridge HB1 connected thereto. The controller 340 may continue driving of the motor by flowing current through the driving unit 352 which is not faulty and winding M2 and M3 of H bridge HB2 and HB3 connected thereto.

When a fault of at least one driving unit is detected, the controller 340 may switch the control mode from n-phase current flow control of flowing current through the windings of n phases to m-phase current flow control of flowing current through the windings of m phases (m is an integer equal to or greater than 2 and smaller than n) other than the windings included in the H bridge connected to the broken driving unit among the at least two driving units. For example, a case of driving a four-phase motor is considered. When a fault of one driving unit is detected, the controller 340 may switch the control mode from four-phase current flow control to three-phase current flow control.

In the first example embodiment of the present disclosure, when a fault of the driving unit 351 is detected, the controller 340 switches the control mode from three-phase current flow control to two-phase current floe mode. The controller 340 flows current through winding M2 and M3 of two phases other than winding M1 included in H bridge HB1 connected to the driving unit 351 which is faulty. Flowing current through the windings of two phases is referred to as ‘two-phase current flow control’. Specifically, the controller 340 performs the two-phase current flow by outputting a PWM signal to the driving unit 351 and controlling the switching operation of the switch elements in the two H bridges HB2 and HB3.

FIG. 9B mimetically shows a case in which a driving unit 352 in the driver 350 which drives a four-phase motor is faulty. The power conversion device of the present disclosure may drive, for example, a four-phase motor. The inverter unit 100 has H bridge of A phase HB1, H bridge of B phase HB2, H bridge of C phase HB3, and H bridge of D phase HB4. For example, H bridge HB1 and HB4 may be connected to the driving unit 351, and H bridge HB2 and HB3 may be connected to the driving unit 352. For example, a case in which the driving unit 352 is faulty is considered. In that case, as the driving unit 351 drives H bridge HB1 and H bridge HB4, the two-phase current flow control of flowing current through the windings of A phase and D phase can be performed. Like this, if there are at least two driving units, driving of the motor can be continued by the two-phase current flow control.

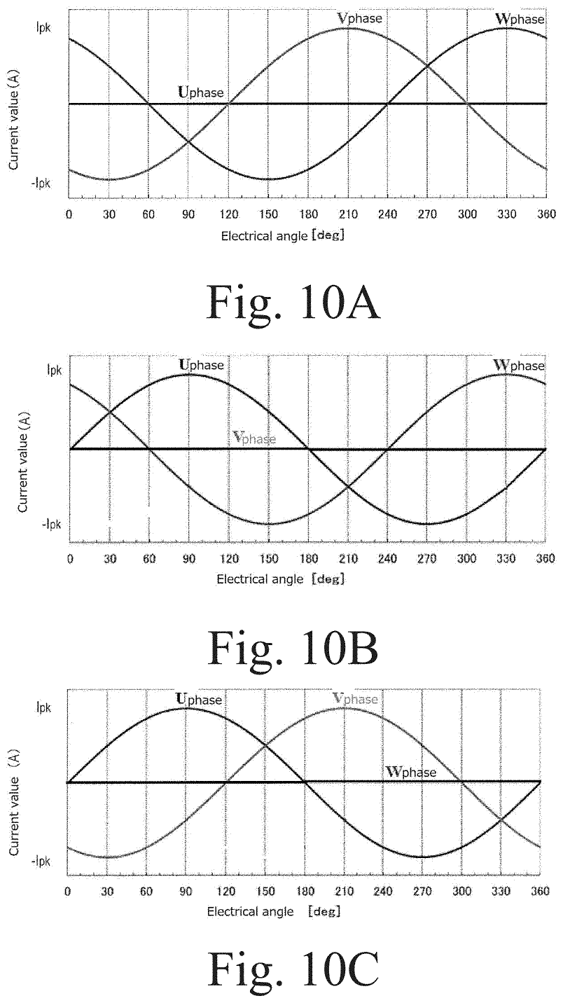

FIG. 10A shows an example of a current waveform obtained by plotting the value of current flowing through the each windings of V and W phases of the motor 200 when the power conversion device 1000 is controlled according to two-phase current flow control. The horizontal axis represents the electrical angle (deg) of the motor, and the vertical axis represents the current value (A). In the current waveform of FIG. 10A, current values are plotted every 30° of the electrical angle. Iₚₖ denotes the maximum current value (peak current value) of each phase. The direction of current shown in FIG. 10A follows the definition described above.

Table 2 shows values of current flowing through the terminal of each inverter at each electrical angle in the waveform of FIG. 10A. The current value at each electrical angle of the current flowing through winding M2 and M3 of V phase and W phase shown in Table 2 is equal to the current value at each electrical angle in the three-phase current flow control shown in Table 1. Since current does not flow through winding M1 of U phase, the current value of the current flowing through winding M1 as shown in Table 2 is zero at each electrical angle.

TABLE 2

| Operation at | | Electrical angle [deg] | | | | | | | | | | | |
|---|---|---|---|---|---|---|---|---|---|---|---|---|---|
| normal times | | 0 (360) | 30 | 60 | 90 | 120 | 150 | 180 | 210 | 240 | 270 | 300 | 330 |
| Bridge | U_L phase | OFF | OFF | OFF | OFF | OFF | OFF | OFF | OFF | OFF | OFF | OFF | OFF |
| circuit L | V_L phase | −I1 | −Iₚₖ | −I₁ | −I₂ | 0 | I₂ | I₁ | Iₚₖ | I₁ | I₂ | 0 | −I₂ |
| | W_L phase | I₁ | I₂ | 0 | −I₂ | −I1 | −Iₚₖ | −I₁ | −I₂ | 0 | I₂ | I₁ | Iₚₖ |
| Bridge | U_R phase | OFF | OFF | OFF | OFF | OFF | OFF | OFF | OFF | OFF | OFF | OFF | OFF |
| circuit R | V_R phase | I₁ | Iₚₖ | I₁ | I₂ | 0 | −I₂ | −I1 | −Iₚₖ | −I1 | −I₂ | 0 | I₂ |
| | W_R phase | −I1 | −I₂ | 0 | I₂ | I₁ | Iₚₖ | I₁ | I₂ | 0 | −I₂ | −I1 | Iₚₖ |

For reference, a current waveform obtained through two-phase current flow control when the winding M2 of V phase and winding M3 of W phase are not used is shown as an example. FIG. 10B shows an example of a current waveform obtained by plotting the value of current flowing through the each windings of U and W phases of the motor 200 when the power conversion device 1000 is controlled according to two-phase current flow control using winding M1 of U phase and winding M3 of W phase. FIG. 10C shows an example a current waveform obtained by plotting the value of current flowing through the each windings of U and V phases of the motor 200 when the power conversion device 1000 is controlled according to two-phase current flow control using winding M1 of U phase and winding M2 of V phase.

According to the first example embodiment of the present disclosure, a single fault of a driving unit does not affect other driving units. In addition, since two inverters are connected to one ends and the other ends of the windings, driving of the motor can be continued by m-phase current flow control using an H bridge other than the H bridge connected to a driving unit which is faulty. For example, when the driving unit 351 among the driving units 351 and 352 is faulty, driving of the motor can be continued by switching the control mode from three-phase current flow control to two-phase current flow control.

The power conversion device 1000A according to a second example embodiment of the present disclosure is different from the power conversion device 1000 according to the first example embodiment of the present disclosure in that a driving unit is installed for each H bridge. Hereinafter, the difference with the power conversion device 1000 will be chiefly described.

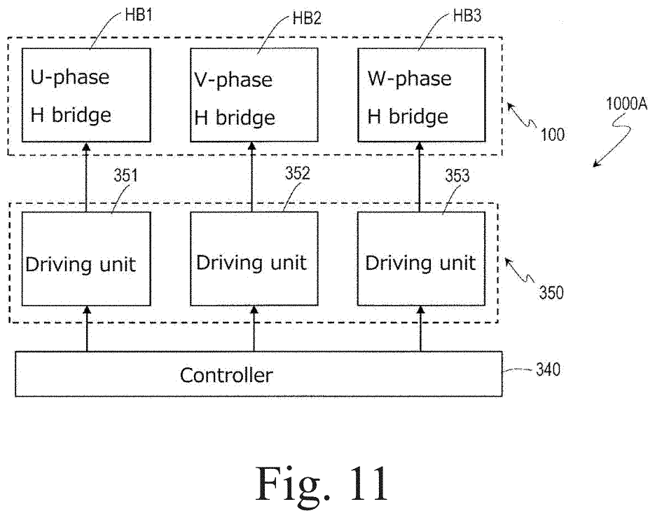

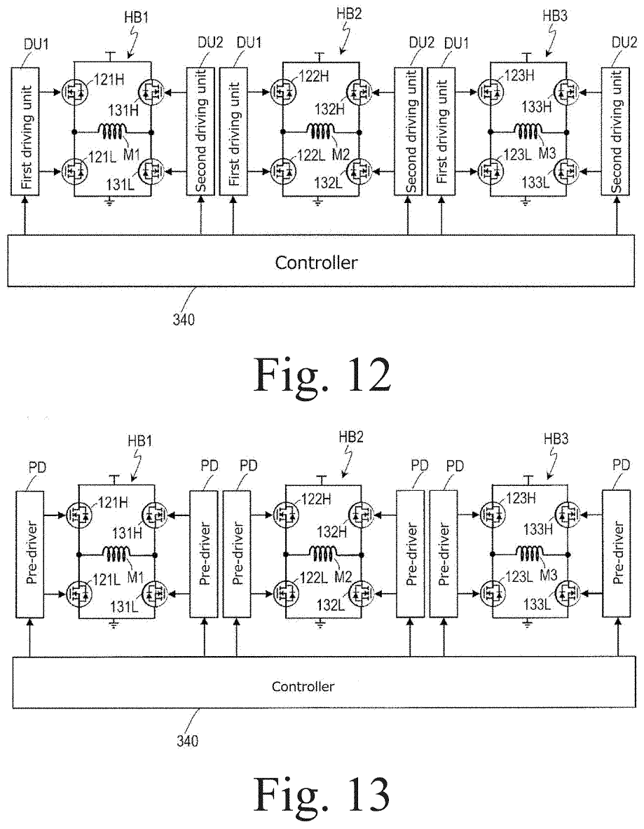

FIG. 11 mimetically shows connection of the driver 350 and the inverter unit 100 and the block configuration of the driver 350. FIG. 12 mimetically shows the block configuration of each driving unit of the driver 350.

The driver 350 includes three driving units 351, 352 and 353. The driving unit 351 is connected to H bridge HB1 and drives H bridge HB1. The driving unit 352 is connected to H bridge HB2 and drives H bridge HB2. The driving unit 353 is connected to H bridge HB3 and drives H bridge HB3.

Each of the driving units 351, 352 and 353 may be, for example, a pre-driver. Alternatively, as shown in FIG. 12, each of the driving units 351, 352 and 353 may have a first driving unit (DU1) and a second driving unit (DU2) as described in the first example embodiment of the present disclosure. The first driving unit (DU1) may be installed in each leg of the first inverter 120 of the H bridge, and the second driving unit (DU2) may be installed in each leg of the second inverter 130 of the H bridge.

FIG. 13 mimetically shows the block configuration in the case where pre-drivers (PD) are used as the first driving unit (DU1) and the second driving unit (DU2) of each driving unit. In the present disclosure, each of the first driving unit (DU1) and the second driving unit (DU2) in at least one driving unit among the three driving units 351, 352 and 353 may be a pre-driver (PD). As shown in the figure, all of the first driving unit (DU1) and the second driving unit (DU2) may be typically a pre-driver (PD). The pre-driver (PD) may be installed in each leg of the first inverter 120 and the second inverter 130 of the H bridge. Alternatively, the driver 350 may be realized by combining various circuits for each driving unit as described below.

For example, each of the first driving unit (DU1) and the second driving unit (DU2) of the driving unit 351 may be a pre-driver (PD). Each of the first driving unit (DU1) and the second driving unit (DU2) of the driving unit 352 may have a boost driving circuit 600 and a driving circuit 610 as shown in FIG. 7B. In that case, all the switch elements of H bridge HB2 are N-channel transistors. Each of the first driving unit (DU1) and the second driving unit (DU2) of the driving unit 353 may have two driving circuits 610 as shown in FIG. 7C. In that case, SW 123H and 133H of H bridge HB3 are P-channel transistors, and SW 123L and 133L are N-channel transistors.

As another example, all of the first driving unit (DU1) and the second driving unit (DU2) in the driver 350 may have a boost driving circuit 600 and a driving circuit 610 as shown in FIG. 7B. Alternatively, all of the first driving unit (DU1) and the second driving unit (DU2) in the driver 350 may have two driving circuits 610 as shown in FIG. 7C.

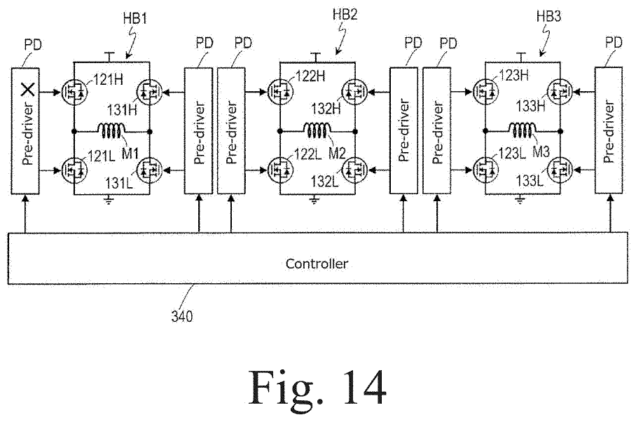

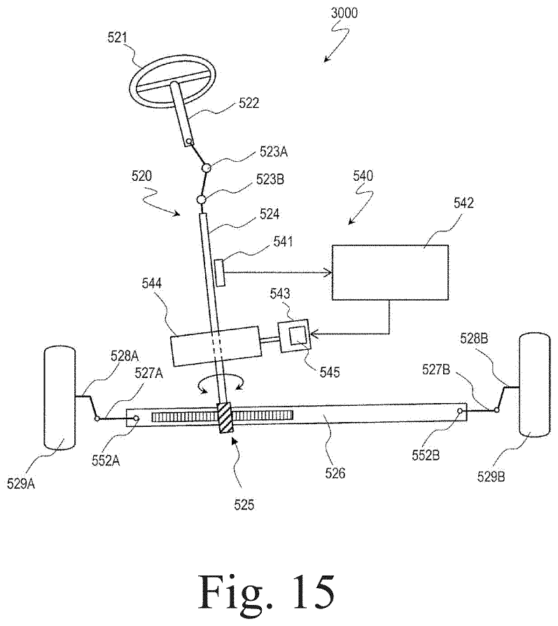

FIG. 14 mimetically shows a case in which the pre-driver (PD) connected to the leg for U phase of the first inverter 120 of H bridge HB1, among six pre-drivers (PDs), is faulty.

When a fault of one among the three driving units 351, 352 and 353, e.g., a fault of driving unit 351, is detected, the controller 340 switches the control mode from three-phase current flow control to two-phase current flow control. As the controller 340 flows current through winding M2 and M3 of two phases other than winding M1 included in H bridge HB1 connected to the driving unit 351 which is faulty, driving of the motor is continued.

According to the second example embodiment of the present disclosure, a single fault of, for example, a pre-driver does not affect other pre-drivers at all, like in the case of the first example embodiment of the present disclosure. In addition, since two inverters are connected to one ends and the other ends of the windings, driving of the motor can be continued by m-phase current flow control, for example, two-phase current flow control, using an H bridge other than the H bridge connected to a broken driving unit.

FIG. 15 mimetically shows the typical configuration of an electric power steering device 3000 according to a third example embodiment of the present disclosure.

Vehicles such as automobiles or the like generally have an electric power steering (EPS) device. The electric power steering device 3000 according to the third example embodiment of the present disclosure has a steering system 520 and an assistance torque mechanism 540 for generating assistance torque. The electric power steering device 3000 generates assistance torque supporting the steering torque of the steering system that is generated as an operator handles the steering wheel. By the assistance torque, the burden of the operator in handling the steering wheel is reduced.

The steering system 520 includes, for example, a steering wheel 521, a steering shaft 522, universal joints 523A and 523B, a rotating shaft 524, a rack and pinion mechanism 525, a rack shaft 526, left and right ball joints 552A and 552B, tie rods 527A and 527B, knuckles 528A and 528B, and left and right steerable wheels 529A and 529B.

The assistance torque mechanism 540 includes, for example, a steering torque sensor 541, an electronic control unit (ECU) 542 for a vehicle, a motor 543, and a speed reduction mechanism 544. The steering torque sensor 541 detects steering torque in the steering system 520. The ECU 542 generates a driving signal on the basis of the detection signal of the steering torque sensor 541. The motor 543 generates assistance torque according to the steering torque on the basis of the driving signal. The motor 543 delivers the generated assistance torque to the steering system 520 through the speed reduction mechanism 544.

The ECU 542 has, for example, a controller 340, a driver 350 and the like according to the first example embodiment of the present disclosure. In a vehicle, an electronic control system having the ECU as a nucleus is constructed. In the electric power steering device 3000, the motor driving unit is constructed by, for example, the ECU 542, the motor 543 and the inverter 545. The motor modules 2000 according to the first and second example embodiments of the present disclosure may be properly used in the unit.

The example embodiments of the present disclosure may be widely used in various devices having various motors, such as a cleaner, a drier, a ceiling fan, a washing machine, a refrigerator, an electric power steering device and the like.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-18. (canceled)

19. A power conversion device to convert power supplied from a power supply into power supplied to a motor including windings of n phases, n being an integer equal to or greater than 3, the power conversion unit comprising:
a first inverter connected to a first end of a winding of each phase of the motor, and including n legs;
a second inverter connected to a second end of the winding of each phase, and including n legs; and
at least two drivers to drive n H bridges including the windings of n phases, the n legs of the first inverter, and the n legs of the second inverter; wherein
each of the n H bridges is connected to any one of the at least two drivers.

20. The power conversion device according to claim 19, wherein at least one driver among the at least two drivers includes:
a first driver connected to a low side switch element and a high side switch element in a leg of the first inverter of an H bridge to supply the low side switch element and the high side switch element with a control signal to control switching operation of the low side switch element and the high side switch element; and
a second driver connected to a low side switch element and a high side switch element in a leg of the second inverter of the H bridge to supply the low side switch element and the high side switch element with a control signal to control switching operation of the low side switch element and the high side switch element.

21. The power conversion device according to claim 19, wherein each of the at least two drivers includes:
a first driver connected to a low side switch element and a high side switch element in a leg of the first inverter of an H bridge to supply the low side switch element and the high side switch element with a control signal to control switching operation of the low side switch element and the high side switch element; and
a second driver connected to a low side switch element and a high side switch element in a leg of the second inverter of the H bridge to supply the low side switch element and the high side switch element with a control signal to control switching operation of the low side switch element and the high side switch element.

22. The power conversion device according to claim 20, wherein each of the first driver and the second driver is a pre-driver.

23. The power conversion device according to claim 20, wherein
the first driver includes:
a first boost driving circuit to supply the high side switch element with a control signal to control switching operation of the high side switch element in a leg of the first inverter of an H bridge, a voltage level of the control signal being higher than a voltage level of the power supply; and
a first driving circuit to supply the low side switch element with a control signal to control switching operation of the low side switch element in the leg of the first inverter, and
the second driver includes:
a second boost driving circuit to supply the high side switch element with a control signal to control switching operation of the high side switch element in a leg of the second inverter of an H bridge, a voltage level of the control signal being higher than a voltage level of the power supply; and
a second driving circuit to supply the low side switch element with a control signal to control switching operation of the low side switch element in the leg of the second inverter; wherein
the high side switch element connected to the first driver and the high side switch element connected to the second driver are N-channel transistors, and the low side switch element connected to the first driver and the low side switch element connected to the second driver are N-channel transistors.

24. The power conversion device according to claim 20, wherein
the first driver includes:
a first driving circuit to supply the high side switch element with a control signal to control switching operation of the high side switch element in a leg of the first inverter of an H bridge; and
a second driving circuit to supply the low side switch element with a control signal to control switching operation of the low side switch element in the leg of the first inverter, and
the second driver includes:
a third driving circuit to supply the high side switch element with a control signal to control switching operation of the high side switch element in a leg of the second inverter of an H bridge; and
a fourth driving circuit to supply the low side switch element with a control signal to control switching operation of the low side switch element in the leg of the second inverter; wherein
the high side switch element connected to the first driver and the high side switch element connected to the third driver are P-channel transistors, and the low side switch element connected to the second driver and the low side switch element connected to the fourth driver are N-channel transistors.

25. The power conversion device according to claim 19, wherein the at least two drivers are n drivers connected to the n H bridges, and the n drivers drive the n bridges, respectively.

26. The power conversion device according to claim 25, wherein each of the n drivers includes:
a first driver connected to a low side switch element and a high side switch element in a leg of the first inverter of an H bridge to supply the low side switch element and the high side switch element with a control signal to control switching operation of the low side switch element and the high side switch element; and
a second driver connected to a low side switch element and a high side switch element in a leg of the second inverter of an H bridge to supply the low side switch element and the high side switch element with a control signal to control switching operation of the low side switch element and the high side switch element.

27. The power conversion device according to claim 26, wherein each of the first driver and the second driver in the at least one driver among the n drivers is a pre-driver.

28. The power conversion device according to claim 26, wherein each of the first driver and the second driver in each of the n drivers is a pre-driver.

29. The power conversion device according to claim 26, wherein
the first driver in the at least one driver among the n drivers includes:
a first boost driving circuit to supply the high side switch element with a control signal to control switching operation of the high side switch element in a leg of the first inverter of an H bridge, a voltage level of the control signal being higher than a voltage level of the power supply; and
a first driving circuit to supply the low side switch element with a control signal to control switching operation of the low side switch element in the leg of the first inverter; and
the second driver in the at least one driver includes:
a second boost driving circuit to supply the high side switch element with a control signal to control switching operation of the high side switch element in a leg of the second inverter of an H bridge, a voltage level of the control signal being higher than a voltage level of the power supply; and
a second driving circuit to supply the low side switch element with a control signal to control switching operation of the low side switch element in the leg of the second inverter; wherein
the high side switch element connected to the first driver and the high side switch element connected to the second driver are N-channel transistors, and the low side switch element connected to the first driver and the low side switch element connected to the second driver are N-channel transistors.

30. The power conversion device according to claim 26, wherein
the first driver in each of the n drivers includes:
a first boost driving circuit to supply the high side switch element with a control signal to control switching operation of the high side switch element in a leg of the first inverter of an H bridge, a voltage level of the control signal being higher than a voltage level of the power supply; and
a first driving circuit to supply the low side switch element with a control signal to control switching operation of the low side switch element in the leg of the first inverter; and
the second driver in each of the n drivers includes:
a second boost driving circuit to supply the high side switch element with a control signal to control switching operation of the high side switch element in a leg of the second inverter of an H bridge, a voltage level of the control signal being higher than a voltage level of the power supply; and
a second driving circuit to supply the low side switch element with a control signal to control switching operation of the low side switch element in the leg of the second inverter; wherein
the high side switch element connected to the first driver and the high side switch element connected to the second driver are N-channel transistors, and the low side switch element connected to the first driver and the low side switch element connected to the second driver are N-channel transistors.

31. The power conversion device according to claim 26, wherein
the first driver in the at least one driver among the n drivers includes:
a first driving circuit to supply the high side switch element with a control signal to control switching operation of the high side switch element in a leg of the first inverter of an H bridge; and
a second driving circuit to supply the low side switch element with a control signal to control switching operation of the low side switch element in the leg of the first inverter; and
the second driver in the at least one driver includes:
a third driving circuit to supply the high side switch element with a control signal to control switching operation of the high side switch element in a leg of the second inverter of an H bridge; and
a fourth driving circuit to supply the low side switch element with a control signal to control switching operation of the low side switch element in the leg of the second inverter; wherein
the high side switch element connected to the first driver and the high side switch element connected to the third driver are P-channel transistors, and the low side switch element connected to the second driver and the low side switch element connected to the fourth driver are N-channel transistors.

32. The power conversion device according to claim 26, wherein
the first driver in each of the n drivers includes:
a first driving circuit to supply the high side switch element with a control signal to control switching operation of the high side switch element in a leg of the first inverter of an H bridge; and
a second driving circuit to supply the low side switch element with a control signal to control switching operation of the low side switch element in the leg of the first inverter, and
the second driver in each of the n drivers includes:
a third driving circuit to supply the high side switch element with a control signal to control switching operation of the high side switch element in a leg of the second inverter of an H bridge; and
a fourth driving circuit to supply the low side switch element with a control signal to control switching operation of the low side switch element in the leg of the second inverter; wherein
the high side switch element connected to the first driver and the high side switch element connected to the third driver are P-channel transistors, and the low side switch element connected to the second driver and the low side switch element connected to the fourth driver are N-channel transistors.

33. The power conversion device according to claim 19, further comprising a control circuit to control the at least two drivers and detect a fault of at least one of the at least two drivers, wherein when the fault of the at least one is detected, the control circuit switches a control mode from n-phase current flow control of flowing current through the windings of n phases to m-phase current flow control, m being an integer equal to or greater than 2 and smaller than n, of flowing current through windings of m phases other than windings included in an H bridge connected to the broken driver among the at least two drivers.

34. The power conversion device according to claim 25, further comprising a control circuit to control the n drivers and detecting a fault of at least one of the n drivers, wherein when the fault of the at least one is detected, the control circuit switches a control mode from n-phase current flow control of flowing current through the windings of n phases to m-phase current flow control, m being an integer equal to or greater than 2 and smaller than n, of flowing current through windings of m phases other than windings included in an H bridge connected to the broken driver among the n drivers.

35. A motor module comprising:
the motor; and
the power conversion device disclosed in claim 19.

36. An electronic power steering device comprising the motor module disclosed in claim 35.
